(19) United States
(12) Patent Application Publication
(10) Pub. No.: US 2012/0105002 A1
(43) Pub. Date: May 3, 2012

(54) METHOD AND APPARATUS FOR AUTOMATED CHARGING OF ELECTRICALLY POWERED MOVING OBJECTS

(75) Inventors: Jostein Eikeland, Boca Raton, FL (US); Stein Christiansen, Parkland, FL (US); Christopher Christiansen, Parkland, FL (US)

(73) Assignee: ALEVO, INC, Boca Raton, FL (US)

(21) Appl. No.: 13/283,959

(22) Filed: Oct. 28, 2011

Related U.S. Application Data
(60) Provisional application No. 61/408,495, filed on Oct. 29, 2010.

(51) Int. Cl. H02J 7/00

(52) U.S. Cl. 320/109

(57) ABSTRACT

An apparatus includes a base plate, one or more lifting mechanisms coupled to the base plate and configured to elevate the base plate, at least one connector coupled to the base plate, an insulation layer coupled to the base plate and at least one connector; one or more power inputs configured to allow electricity flow to or from the at least one connector; and a control unit coupled to the one or more power inputs and configured to control the flow of electricity.

### CROSS REFERENCE TO RELATED APPLICATIONS

This application claims the benefit of U.S. Provisional Application No. 61/408,495, filed Oct. 29, 2010, which is incorporated herein by reference in its entirety for all purposes.

### BACKGROUND

Battery electric and electric plug-in hybrid vehicles are developing rapidly in order to reduce the dependence on oil as an energy source. New and strict pollution policies are forcing the development of transportation means that can use renewable energy and reduce the emission of greenhouse gases.

Electric vehicles require an energy delivery infrastructure that can provide electricity at various locations, and is capable of delivering enough load to allow for fast charging time. The mass adoption of electric vehicles demands a system where large amount of energy can be transferred quickly, safely and with an automated charging cycle.

Smart-grids and charge-points are costly to deploy and require upgrades at the charge locations. Additionally, charge points without the ability to transfer high amounts of energy in a short time are not sufficient for electric vehicles, machinery or equipment that requires large amounts of energy during a short period of time.

The continuous development of new batteries will enable electric and hybrid vehicles to charge faster without the risk of overcharge and explosion. Also, as batteries reduce in price and their capacity increases, more personal and commercial electric drive vehicles will be developed.

A common barrier to adopting electric vehicles is the risk of operators forgetting to plug in their electric or hybrid plug-in vehicle. If electric vehicles are going to be adopted by businesses such as delivery companies and courier services, they will not be able to afford any delay due to insufficient charge at the beginning of a work day. Therefore, there is a need for a charger that is capable of automatically connecting to a vehicle. This will eliminate the risk for having depleted batteries at the beginning of a duty cycle.

Embodiments of the invention address these and other problems individually and collectively.

### BRIEF SUMMARY

One embodiment of the invention is directed to an apparatus having a base plate, a lifting means configured to elevate the base plate, a connector, an insulating layer coupled to the base plate and at least one connector, a power input configured to allow electricity flow to or from at least one connector; and a control unit coupled to the power input and configured to control the flow of electricity.

Another embodiment of the invention is directed to an insulation layer that is configured to conduct electricity when the base plate is elevated and the insulation layer is pressed against an object.

Another embodiment of the invention is directed to charge rails configured to be coupled to batteries and capable of conducting bi-directional energy flow between the batteries and a charger when the charger is connected to the charge rails.

Another embodiment of the invention is directed to providing guidance to an operator to park a vehicle on top of a charger, sending a command to the charger to be lifted and connected to a designated part of the vehicle; and initiating flow of electricity between the charger and one or more batteries coupled to the vehicle.

Another embodiment of the invention is directed to directing the flow of electricity from one or more batteries to the charger.

The following detailed description and the accompanying drawings provide a better understanding of the nature and advantages of the present invention.

### BRIEF DESCRIPTION OF DRAWINGS

FIG. 1 is a schematic drawing of an electric vehicle chassis with an electric charging system installed at a designated charge spot, according to an embodiment of the invention.

FIG. 2 is a modular illustration of an electric vehicle, according to an embodiment of the invention.

FIG. 3 is an illustration of the charger's conductive bridge, according to an embodiment of the invention.

FIG. 4 is a schematic illustration of the conductive bridge when not connected to a vehicle, according to an embodiment of the invention.

FIG. 5 is an illustration of the charger with control center and conductive bridge, according to an embodiment of the invention.

FIG. 6 is an illustration of the charger connected to a vehicle and initiating charge/discharge, according to an embodiment of the invention.

FIG. 7 is a schematic illustration of the conductive bridge when connected to a vehicle, according to an embodiment of the invention.

FIG. 8 is a flowchart of the chargers' connection and charging sequence, according to an embodiment of the invention.

### DETAILED DESCRIPTION

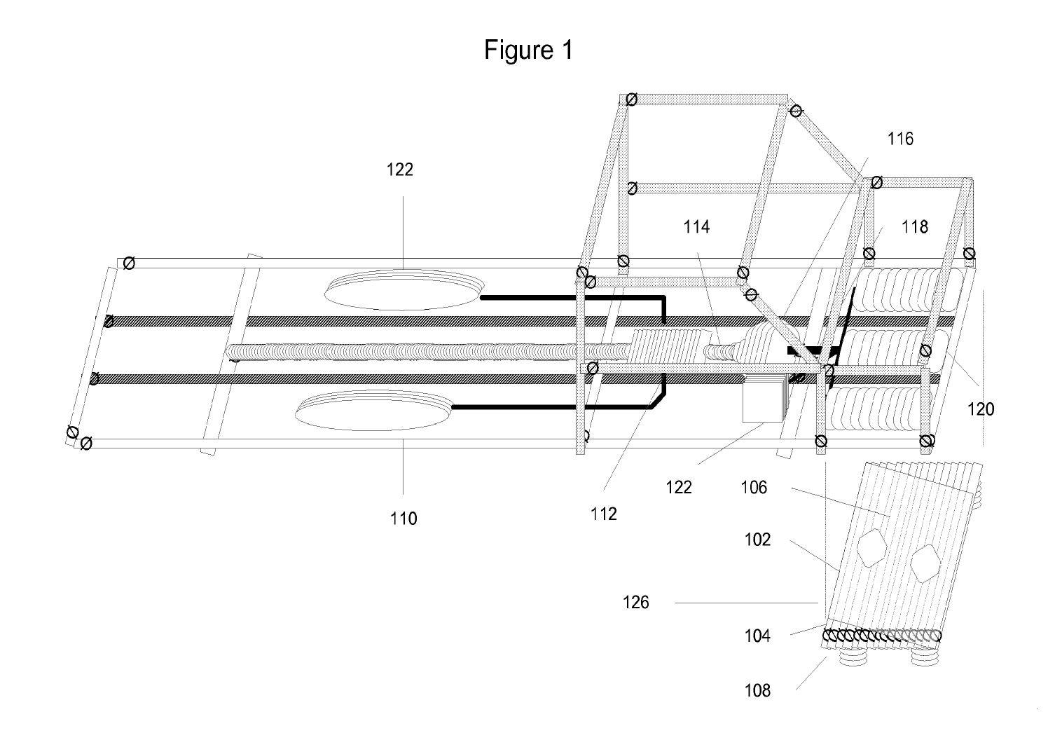

FIG. 1 is an illustration of a vehicle and conductive bridge 126. In one embodiment, the vehicle is illustrated as an electric hydraulic vehicle; however, the vehicle may be any moving object propelled by electric power, including all electric and hybrid electric objects. The vehicle may have an electric motor 116 driving the hydraulic pump 112 through the interface 114 which is in between the motor 116 and hydraulic pump 112. The pump 112 rotates the driveshaft by pumping fluid between the low pressure reservoir 110 and high pressure reservoir 122.

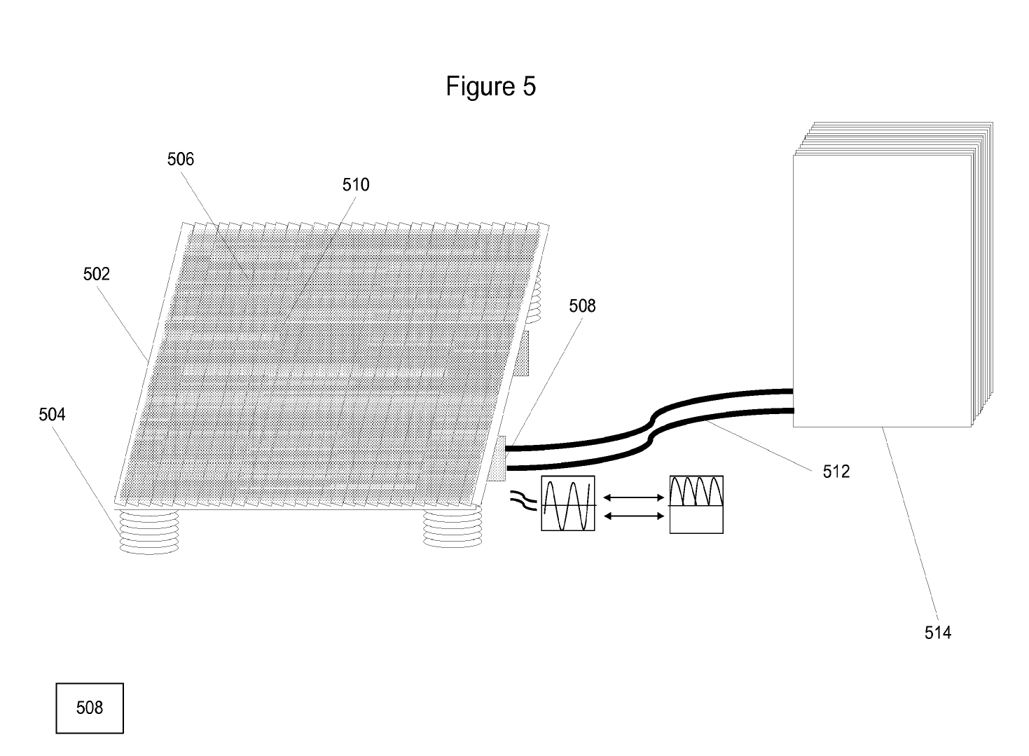

Batteries 120 may be any type of organic or inorganic rechargeable battery including lithium-ion, lead-acid, nickel metal hydride, sodium and lithium metal. Batteries 120 may be connected to the electric motor 116 through the battery connection 118. Electric motor 116 may be any type of electric motor including direct current and alternating current motors. Batteries 120 may be connected to the onboard computer through the vehicle's telemetric unit 124. The telemetric unit 124 may identify type of batteries 120, measure the State of Health (SoH) and State of Charge (SoC) of the vehicle batteries 120 and interface with the chargers control unit 514 (FIG. 5).

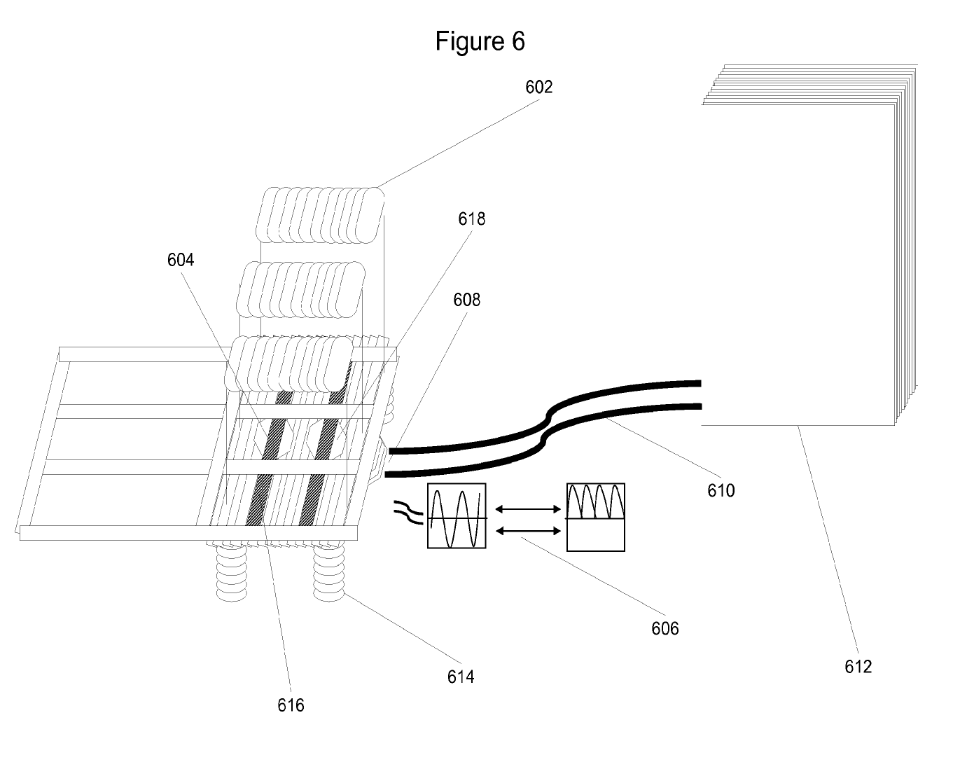

In some embodiments, the conductive bridge 126 may be installed at the vehicle's home base or other designated charge location such as on route charge spots. In some embodiments, the conductive bridge 126 may be installed domestically at a personal residence. The charger's rate of charge may depend on the power input; therefore, in some embodiments, the charging system may have a separate installation procedure for a commercial location and a personal residence. In some embodiments, the charger that is installed in a commercial location may be directly connected to the power grid. The power input may therefore be variable and can be configured based upon the voltage provided by the power grid. When installed in a domestic residence, the charging system may receive power from existing plugs and wiring. To increase the power input, the chargers' control unit 612 (FIG. 6) may accept multiple power inputs from multiple outlets.

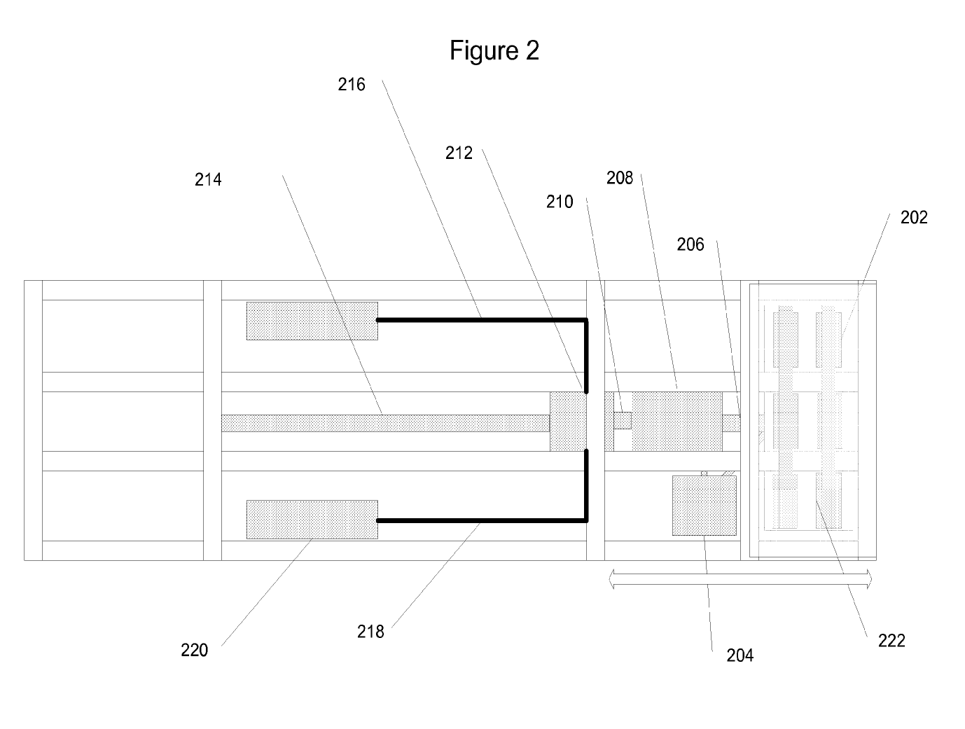

Conductive Bridge 126 may have a lift 108. Lift 108 may use any suitable mechanism for lifting the charger. For example, the lift 108 may be a hydraulic lift or an electric lift. Base plate 104 may be any solid surface including iron, aluminum, magnesium or plastic. Charge connectors 102 may be any conductive material such as aluminum, copper, gold or platinum. The charge connectors 102 connect to a vehicle's charge rail 202 (FIG. 2.) when the conductive bridge 126 is lifted.

As the conductive bridge 126 may be capable of transferring high amounts of energy in a short time, the conductive bridge 126 may have an insulation layer 106 for safety purposes. The insulation layer 106 prevents the charge connectors 102 from being exposed when the charger is not connected to the charge rail 202. After the vehicle has aligned its position with the conductive bridge 126, the lift 108 will raise the conductive bridge 126 in order for the charge connectors 102 to connect with the charge rail 202. The insulation layer 106 may be pressed thin when the conductive bridge 126 is lifted, therefore enabling the charge connectors 102 to connect to the charge rail 202 and transfer energy. The insulation layer 106 may be any type of insulation material that allows electricity to flow when compressed. In one embodiment, the insulation layer 106 may be a thixotropic polymer blend with metal powder such as zinc, copper, silver and/or aluminum (although any material with equal characteristics may be used). To ensure a safe charge sequence, the areas not pressurized against the charge rail 202 may not be able to conduct electricity.

FIG. 2 illustrates the key components enabling the vehicle to connect to the conductive bridge 126. The charge rail 202 may be located horizontally or vertically to ensure proper connection to the battery modules 222. Battery modules 222 may be configured to supply any voltage based upon the requirements of electric motor 208. The type and size of electric motor 208 and, in some embodiments, hydraulic pump 212 and any type of internal combustion motor (not illustrated) may vary based upon size and desired duty cycle of the vehicle. In some embodiments, telemetric unit 204 may recognize and communicate the vehicle's setup to charger control unit 514 (FIG. 5) to perform vehicle diagnostics for optimal charging.

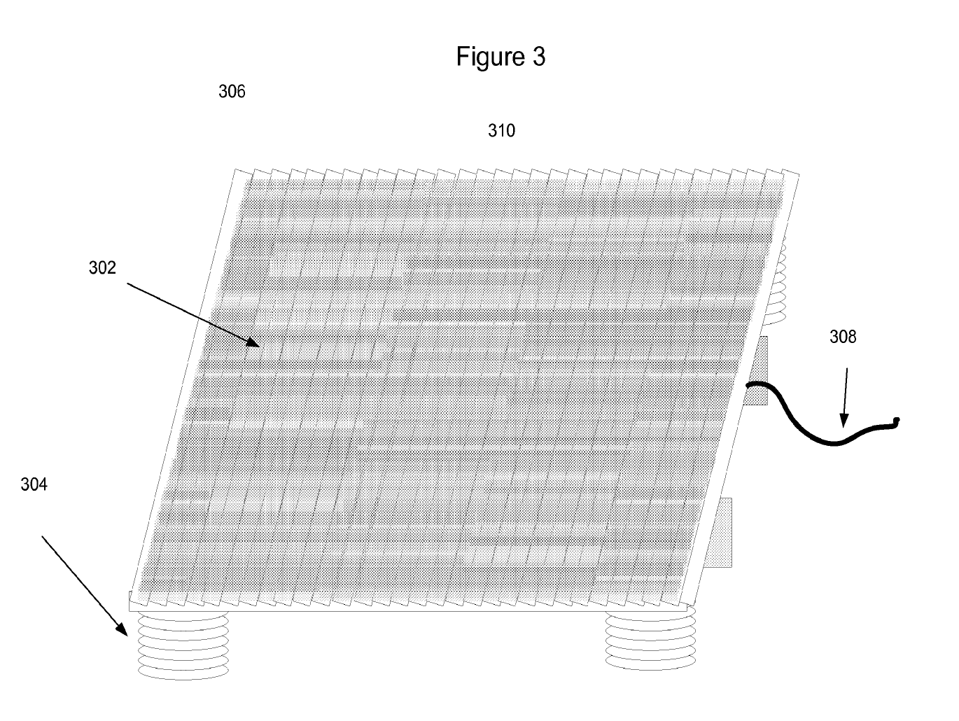

FIG. 3 is an illustration of the conductive bridge 126 (FIG. 1). In one embodiment, the lift 304 may be a cylindrical electric hydraulic lift, but may also be a scissor lift or an in-ground cassette lift. Since the conductive bridge 126 may be capable of rapid energy transfer, the power input 308 from the chargers' control unit 514 (FIG. 5) may be high voltage and high current. In one embodiment, conductor material in the power input 308 may be an aluminum alloy made into several strands and may be reinforced with steel strands. In other embodiments, the power input 308 may also be copper, platinum or gold wiring.

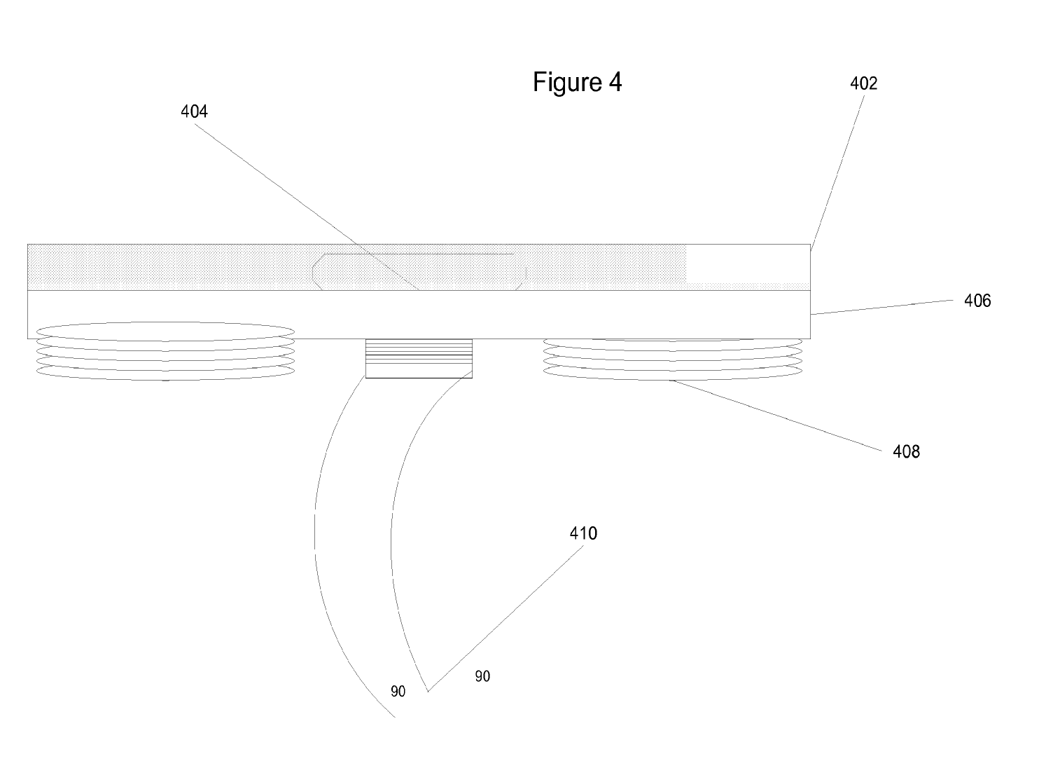

FIG. 4 is a schematic illustration of the conductive bridge when not connected to the charge rail 202 (FIG. 2). The insulation layer 402 will not conduct electricity until it is pressed against an object. Charge connector 404 may be covered by the isolation layer 402 and may therefore be safe to keep in an exposed environment. Also, the base 406 may remain level to the ground when not engaged.

Power input 410 may be any suitable type of power cable depending on the type of vehicle the charger is connecting to and/or the physical location of the charger. The charger 612 (FIG. 6) and conductive bridge 126 (FIG. 1) may be capable of variation of voltages from a basic 110 volts to an excess of 1000 volts with an ampere rating from 20 to an excess of 2500 amperes. Each charger 612 (FIG. 6) may have adjustable voltages at each designated charge spot enabling any vehicle's battery configuration 602 to utilize the charger.

Charger 612 may charge the connected vehicle's battery pack 602 (FIG. 6) or discharge the batter pack 602 and supply the charge to the power grid through its connection to the power grid (not illustrated). The charge and discharge of the battery pack 602 may be based upon instructions from the governing utility company, individual service operator, vehicle presets or the charger's control unit. In some embodiments, the governing utility company may use the battery pack 602 to regulate the power grid. In some other embodiments, the charger's control unit may be setup to sell back the energy to the utility company during the peak hours when the price of energy is higher.

FIG. 5 illustrates the complete charge system when not connected to a vehicle. The charger's control unit 514 may interface with the grid and is capable of bidirectional energy flow. Control unit 514 may receive and transfer information wirelessly or through PLC (power line communication). Control unit 514 may communicate through standards such as SCADA (supervisory control and data acquisition), IEEE Synchrophaser C37.118, IEC60870, Zigbee and IEC 61850. Charger's control unit 514 may convert from alternating current to direct current using a full bridge rectifier 512.

The charger's control unit 514 may communicate with the vehicle's telemetric unit 124 wirelessly. The control unit 514 can determine the type of battery, SoC, SoH and vehicle presets in order to initiate correct charge algorithm and determine whether the vehicle will charge the batteries or discharge stored energy back into the grid.

FIG. 6 illustrates the complete charge system with the charge connectors 618 connected to the charge rail 604. The electric hydraulic lift 614 may be extended and apply pressure to the insulation layer, and when pressed against the charge rails under the vehicle, the conductive material conducts electricity and charges or discharges the battery.

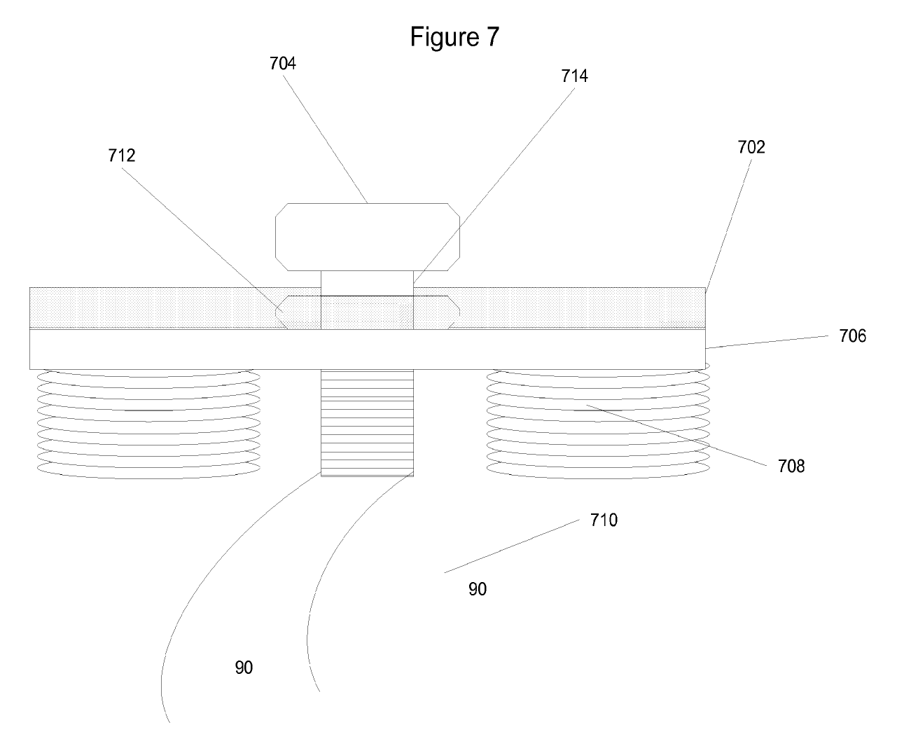

FIG. 7 is a diagram of the conductive bridge when connected to the vehicle's charge rail 714. To allow for a flexible parking of the vehicle, the charge connectors 712 may be larger than the charge rail 714 and may allow the vehicle a flexible parking range rather than requiring the vehicle to be directly above the charge connector 712. As the insulation layer 702 may only let the area under pressure to be able to conduct electricity, the exact positioning of the vehicle may not be important. Energy supply 710 may follow the base 706 as the lift 108 (FIG. 1) raises the conductive bridge to the vehicle.

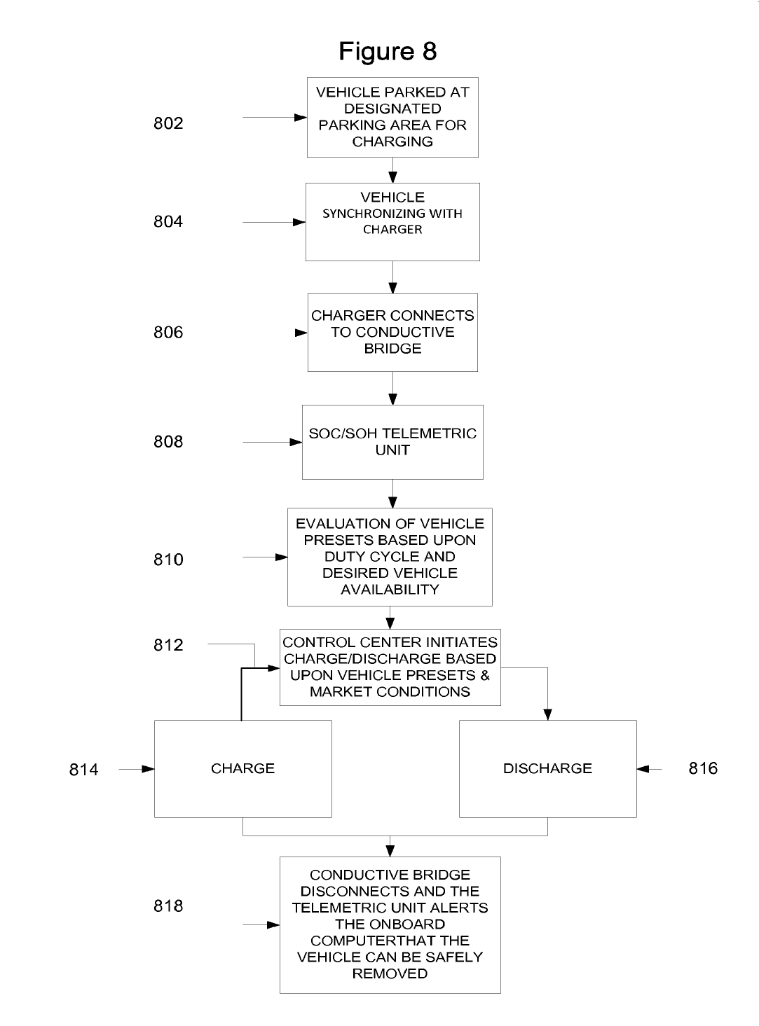

FIG. 8 is a flowchart of the sequence of events from the time when a vehicle pulls into its designated charge spot until charge or discharge sequence is completed. As an initial step, the vehicle may park in its designated spot located above the in-ground charger (step 802). The telemetric unit 204 may synchronize with the conductive bridge 126 to determine the vehicle's position and guide the vehicle to the correct location (step 804). The synchronization and guidance step may be performed through infrared, acoustic, capacitive and inductive sensors combined with an operator alert system informing the driver when parked correctly. In one embodiment, the sensors may measure distances from micro inches to more than 100 feet by using the principle of transmitting light or sound from the sensor transmitter(s) mounted on the vehicle towards the other object, and recording the echo from such object and compute the distance. In one embodiment, the protocol used for Distance-Proximity sensors may the Modbus protocol. In some embodiments, the Modbus protocol may be interfaced to the vehicle's CAN (Controller Area Network) bus and may be controlled/monitored via the SAE J1939 protocol by the onboard telemetric unit or the control center. In some embodiments, sensors may be connected through RS-232 and RS-485 serial interfaces. Other communication protocols used may also be NEMA 2000 and ISO 11783. In some embodiments, sensors that are used may follow standard IEC 60947-5-2 that defines the technical details of proximity sensors.

In one embodiment, the synchronization (step 804) may commence as the vehicle approaches the designated parking/docking location. Upon approach, the onboard sensor may activate a sound signal as well as a blinking warning light to inform the driver that the he/she is on the correct path. When the sound signal and warning light are continuous, the object may be in the correct parking area and charging/discharging can commence (step 806).

Upon confirmation that the vehicle is positioned in an appropriate spot, the charger's control unit 612 may instruct the conductive bridge 126 (FIG. 1) to rise up and connect to the charge rail 202 (FIG. 2). In step 808, the telemetric unit 204 may transmit the battery type, SoC and SoH to the control unit 612. In step 810, the charger's control unit 612 may evaluate the current market conditions and based upon vehicle presets initiate charge (step 814) or discharge (step 816). Upon completed charge or discharge cycle, the charger's control unit 612 (FIG. 6) may communicate with the onboard telemetric unit 204 that the charge cycle is completed and instruct the conductive bridge 126 (FIG. 1) to retract (step 818).

The above description is illustrative and not restrictive. Many variations of the embodiments of the invention will become apparent to those skilled in the art upon review of this disclosure. The scope of the invention should, therefore, be determined not with the reference to the above description, but instead should be determined with reference to the pending claims along with their full scope or equivalents.

The functions described in this application may be implemented as software code to be executed by one or more processors using any suitable computer language such as, for example, Java, C++ or Perl using, for example, conventional or object-oriented techniques. The software code may be stored as a series of instructions, or commands on a computer read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Some embodiments of the present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings herein, a person of ordinary skill in the art will appreciate other ways and/or methods to implement the present invention.

In embodiments, some of the entities described herein may be embodied by a computer that performs any or all of the functions and steps disclosed.

What is claimed is:

1. An apparatus comprising:
a base plate;
one or more lifting mechanisms coupled to the base plate and configured to elevate the base plate;
at least one connector coupled to the base plate;
an insulation layer coupled to the base plate and the at least one connector;
one or more power inputs configured to allow electricity flow to or from the at least one connector; and
a control unit coupled to the one or more power inputs and configured to control the flow of electricity.

2. The apparatus of claim 1, wherein the insulation layer is configured to conduct electricity when the base plate is elevated and the insulation layer is pressed against an object.

3. An apparatus comprising;
One or more charge rails configured to be coupled to one or more batteries and capable of conducting bi-directional energy flow between the batteries and a charger when the charger is connected to the one or more charge rails.

4. The apparatus of claim 3, further configured to be coupled to an electrically powered vehicle.

5. A method comprising:
Providing guidance to an operator to park a vehicle on top of a charger;
sending a command to the charger to be lifted and connected to a designated part of the vehicle; and
initiating flow of electricity between the charger and one or more batteries coupled to the vehicle.

6. A method of claim 5, further comprising:
Directing the flow of electricity from the one or more batteries to the charger.

7. A system comprising:
A processor;
a computer readable storage medium coupled to the processor configured to store program code executable by the processor to:
provide guidance to an operator to park a vehicle on top of a charger;
send a command to the charger to be lifted and connected to a designated part of the vehicle; and
initiate flow of electricity between the charger and one or more batteries coupled to the vehicle.
